(19) United States
(12) Patent Application Publication
(10) Pub. No.: US 2010/0318849 A1
(43) Pub. Date: Dec. 16, 2010

(54) RUNTIME BEHAVIOR ALTERATION USING BEHAVIOR INJECTION HARNESS

(75) Inventors: Victor Magidson, Issaquah, WA (US); Dwight Kruger, Seattle, WA (US); Dennis Doom, Redmond, WA (US); Alejandro Romero, Mexico City (MX)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/482,609

(22) Filed: Jun. 11, 2009

(51) Int. Cl. G06F 11/28; G06F 11/36

(52) U.S. Cl. 714/32; 714/38; 714/E11.178; 714/E11.208

(57) ABSTRACT

Behavior Request is passed by a behavior injection harness specifying a particular behavior point, component, configuration or machine state, iteration (or sequence) to execute, product-independent atomic operation or to send data to be consumed by product code. Behavior requests can be configured and passed to a product process during runtime to change the state of a thread without affecting rest of deployment or configuration.

### BACKGROUND

Exercising all required code paths in a regular test environment is prohibitive from cost and time perspectives. A number of valid customer scenarios require special conditions, including but not limited to, timing, latency, synchronization, failure condition, custom user configuration, and the like, necessitating exploration of cost- and time-consuming code paths.

In order to achieve proper test coverage, it is typically necessary to alter the behavior of product components representing both valid and failure conditions including response override from particular components, latency alteration of individual operations, or synchronization of threads or of processes.

As such, a key necessity in test coverage is to allow full control over sequence of alterations, affecting individual operations or groups of operations. A multitude of injection tools do not meet this key necessity as they work at operating system level or are focused on error scenarios only. Thus, they fail to implement and mimic business logic of the tested application(s).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to use of Behavior Injection Harness (BIH) to induce a desired state in a software product process. A desired state is induced in a software product process by a BIH consumer receiving a behavior request from a BIH controller running in a test environment.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating a high level interactions between BIH enabled client computer with a server running a BIH controller;

FIG. 2 is a diagram illustrating an example Behavior Injection Harness (BIH) system, where embodiments may be implemented for injecting behavior requests into product processes during runtime;

FIG. 3 is an action diagram illustrating interaction of components in an example BIH system during behavior injection execution;

FIG. 4 is a block diagram illustrating interactions between components in an example BIH system using a filter to load BIH components;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing BIH interaction with BIH enabled product.

### DETAILED DESCRIPTION

As briefly described above, a Behavior Injection Harness (BIH) may be used to induce a state in a product process. A behavior request submitted by a BIH controller in a test executable process running in a test environment, may be received by a BIH consumer in a product process running in a production environment, and induce the product process to enter desired state. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “BIH” refers to a Behavior Injection Harness used in a diagnostics environment to induce desired state(s) in product process(es). The term BR refers to a Behavior Request which is a call by a BIH controller to induce desired state in the product process(es). The term BR refers to a Behavior Point which is state in a product process(es) that can be induced by BIH consumer in the product process(es) upon receiving a BR from BIH controller. The term product process is any process running in a production environment. And, the term test executable process is a process running the BIH controller in a diagnostics server.

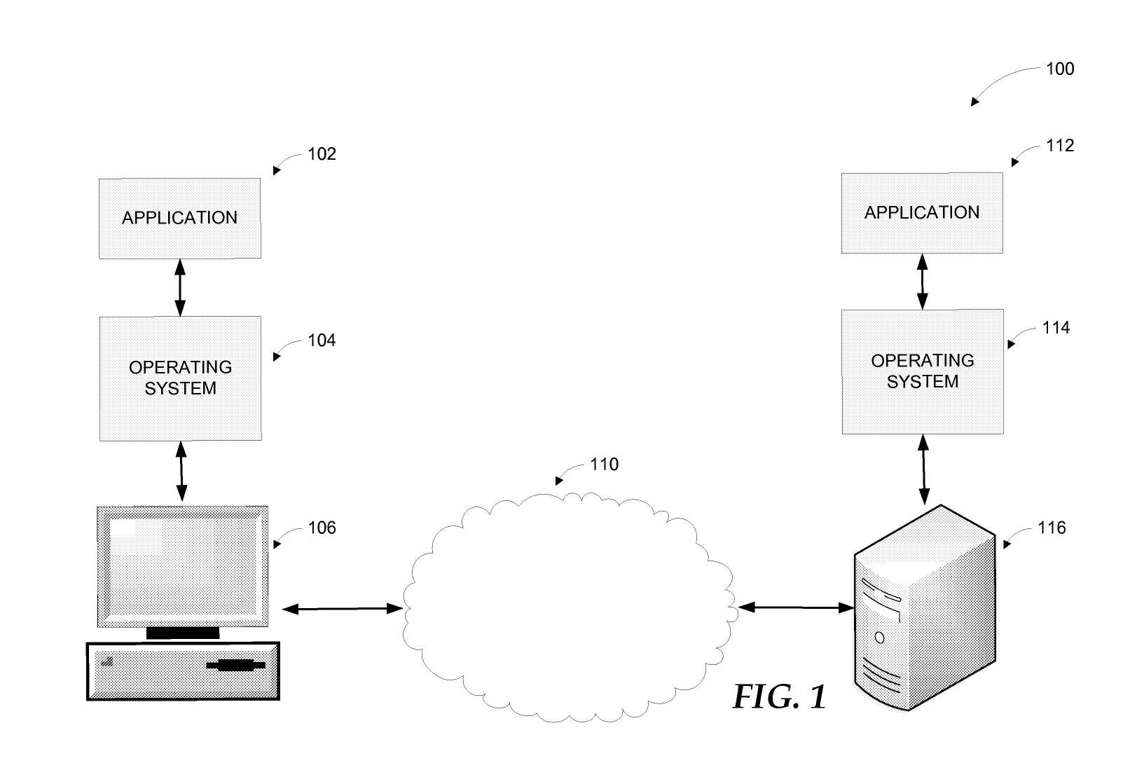

FIG. 1 is a conceptual diagram illustrating high level interactions between a BIH enabled client computer 106 and server 116 running BIH. It may be difficult to duplicate an error state in computer 106 running an application 102 on an operating system 104. A diagnostic server 116 may be running a different operating system 114 than the operating system of the computer 106 and a test application 112 may not be configured in similar manner as the application 102 running at the computer 106.

In some cases, it may take a long time to duplicate the state of the computer 106 on the server 116. Moreover, duplication may be cost prohibitive in a diagnostic environment from a time or resource perspective. In a system according to embodiments, a BIH controller running on the diagnostics server may send BR via shared memory 110. BIH consumer(s) running on the desktop computer may move the desktop computer to desired state facilitating diagnostics session. An example scenario may involve sending a BR to a desktop computer where a word processing application may move to “can't save file due to disk space shortage” state when the BIH consumer receives the BR.

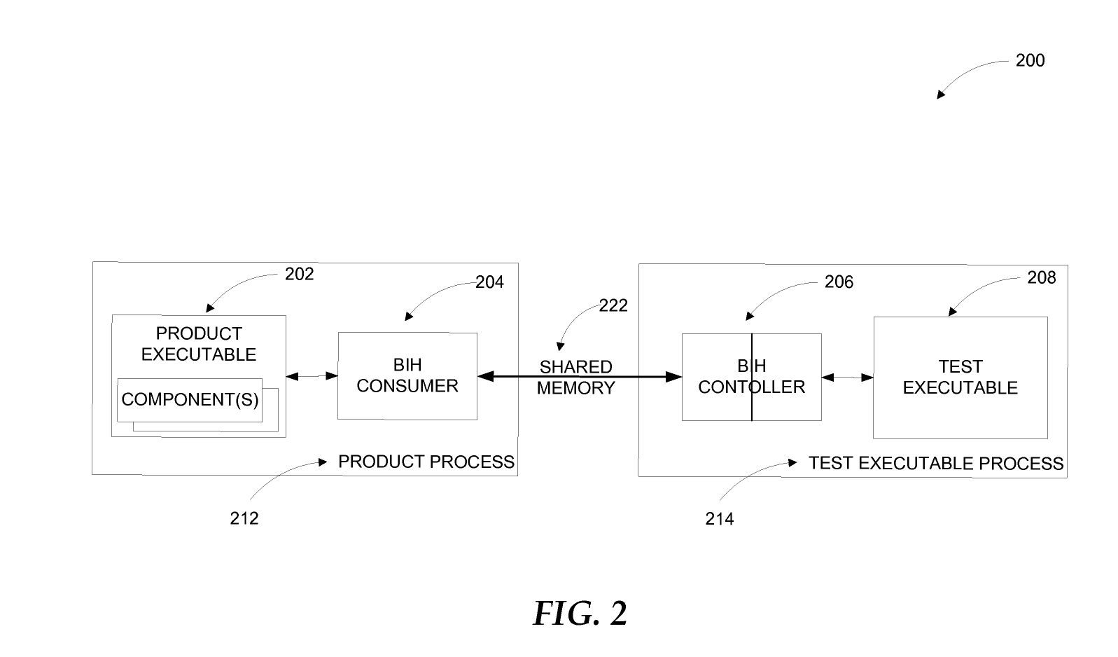

Referring to FIG. 2, diagram 200 of an example BIH system, where embodiments may be practiced, is illustrated. BIH implementation in diagram 200 involves two major components. One of the components encompasses product process 212, an example of which may be a process running on an application at a client desktop computer. The other component encompasses a test executable process, an example of which may be a process running on diagnostics software executed at a customer support server.

Product process 212 is initiated by product executable 202 having multiple components interacting with BIH consumer 204. BIH consumer may be a COM object that hooks to product process. BIH consumer is discoverable from outside the product process to enable moving the product process to a desired state or condition. As mentioned above, it is prudent to have BIH consumer 204 to be able to move the product process to reach a desired state in order to reach testing conditions faster, simulate specific behavior, reach a desired state more efficiently, and many other similar reasons.

BIH consumer may cause the product process 212 to reach the desired state by performing atomic operations or by delivering data to the product process. Atomic operations, in particular, allow altering the state of a product process thread. While there are many examples of altering state of a thread, some common examples are sleep, synchronize, throw, CPU consumption, memory consumption, or lock operations. As such, being a component of the product process enables BIH consumer to directly affect the product process by altering the state of a product process thread. Moreover, multiple BIH consumers may be loaded by a single product process or multiple product processes.

Test executable process 214 is initiated by test executable 208 interacting with BIH controller 206. Examples of a test executable include automation software, diagnostics consoles, and other similar software. BIH controller creates and initializes a shared memory file 222. The shared memory file is used to communicate with one or more BIH consumers 204. The BIH controller 206 provides the interface to transfer data from the test executable 208 to the product executable 202. The BIH controller 206 also exposes an interface to define a BR with specification of a particular atomic operation or data to be transferred to enable product process to reach desired state.

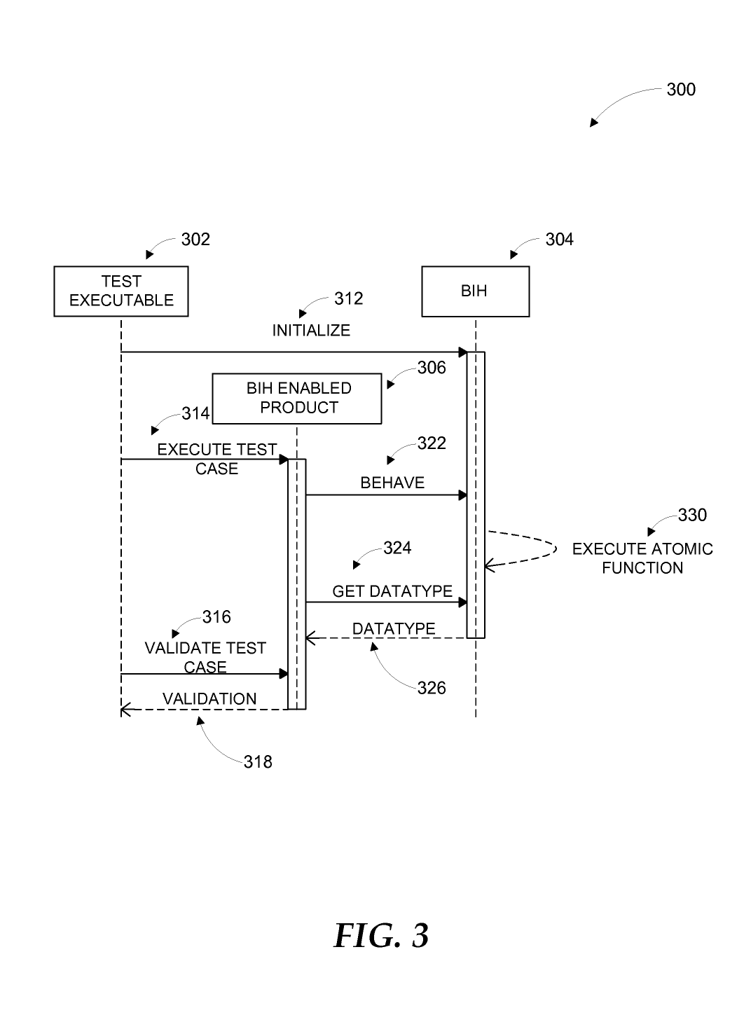

FIG. 3 includes action diagram 300 illustrating interaction of components in an example BIH system during behavior injection execution. A system according to embodiments may include three actors: test executable 302, BIH 304, and BIH enabled product 306. The test executable may initialize BIH (312). Upon initialization, BIH is ready to interact with BIH enabled product. COM objects are part of this interaction as previously mentioned. The test executable 302 may execute a test case 314, which causes BIH enabled product 306 to pass a control (Behave 322) to BIH. To pass a control the enabled product calls an interface in an interface in BIH consumer providing identification of the reached BP. Upon receiving the identification of the reached BP, an atomic function 330 may be executed. If atomic operation was not requested, provided data is passed (Get DataType 324) to the enabled process which makes a decision whether to perform an action upon the provided data. For better induction of state, BIH enabled product 306 may receive data type information 326. BIH 304 may optionally return data type information 326 to BIH enabled product to more accurately induce the desired state. Moreover, the test executable 302 may verify the state of BIH enabled product 306 by submitting a validation test case 316 to BIH enabled product 306 and receiving the validation 318.

Furthermore, BIH enabled product code is instrumented with Behavior Points (BPs). Each BP may specify a unique ID. Each Behavior Request (BR) may contain a BP unique ID, a BIH consumer ID or context, data to be passed to a product process, and the number of times the BP is expected to be reached before performing the BR.

Additionally, a flexible condition specification may allow injection behavior alteration in very particular and well defined scenarios. An example is when the state of the system allows changing of the business logic to a desired state. Also, a set of BRs may be utilized in building a BR scenario which may be replayed for exact reproduction of a particular behavior.

Implementation of the product process may complicate the use of the data delivered by BR. An example is an override of result code returned from one sub-component to another (i.e. HRESULT override). A more sophisticated example is a thrown custom exception with given type when a provided condition may be met.

In another embodiment, all BIH consumers may watch for changes in a set of specified BRs. Once a new BR is submitted by a BIH controller, the BR becomes available for all BIH consumers for execution. An example is a Live Update® feature by Microsoft Corp of Redmond, Wash., which allows flexible control over process behavior without interruption of a test flow. This embodiment may be particularly implemented in testing of services or any other long-running processes. BIH consumer may be available for instrumentation of native (C++) and managed (C#) code. Furthermore, BIH controller may be used from an automated code as well as from a Behavior Injection Console.

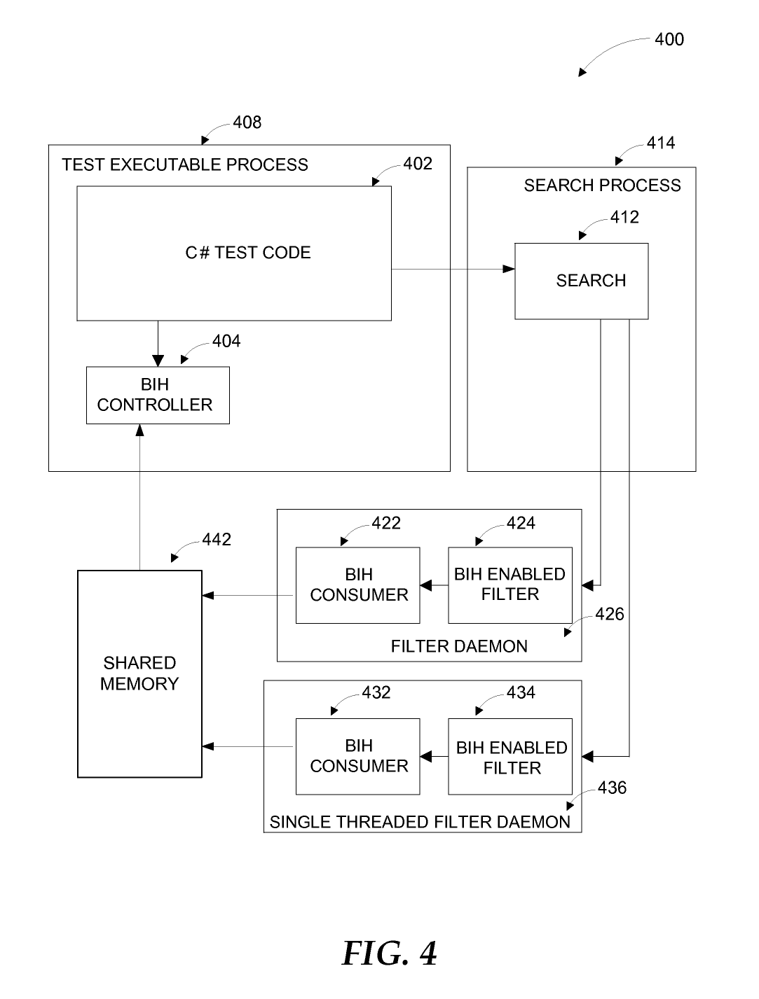

FIG. 4 includes block diagram 400 illustrating interactions between components in an example BIH system using a filter to load BIH components. Test Code 402 initializes the BIH controller 404. A first BIH enabled filter 424 is initialized by a first filter daemon 426. Another BIH enabled filter 434 is initialized by the single threaded filter daemon 436.

Test code 402 pushes a file recognized by the BIH enabled filter 424 to example process search 412. Search 412 creates the filter daemon process 426 and loads the BIH enabled filter 424. The filter is instrumented to load the BIH consumer 422 with BPs in appropriate places.

The BIH consumer 422 connects to the shared memory 442 populated and maintained by the BIH controller 404 to obtain the BRs defined for this particular component configuration. This configuration can be identified by the name of the component or the number of times the component was loaded.

Once a BP is accessed on the filter's code, which is instrumented with the appropriate BPs, the list of BRs obtained from the shared memory file is checked. The instrumentation introduces Behavior Points, which are been accessed on the filter's code. Behavior Requests (BRs) are passed from the controller and are processed. If a match is found then either an atomic operation is executed or data returned to the BIH consumer according to the processed BR.

If search 412 detects a conflict, it terminates the first filter daemon process. The single threaded filter daemon 436 is created. At this point the BIH enabled filter 434 creates another BIH consumer 432, which may or may not get another BR and process accordingly.

The above described systems, components, configurations, and interactions are for illustration purposes only and to not constitute a limitation on embodiments. Runtime behavior alteration using a behavior injection harness may be implemented with other components, configurations, and interactions using the principles discussed herein.

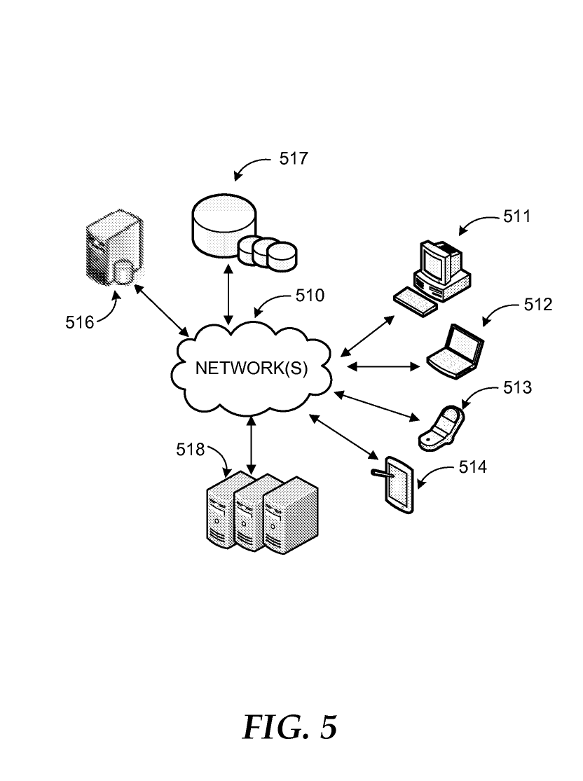

FIG. 5 is an example networked environment, where embodiments may be implemented. A BIH system providing diagnostics services conveying BR(s) for invoking states in product process(es) may be implemented via software executed over one or more servers 518 such as a hosted service. The system may facilitate communications between client applications on individual computing devices such as a handheld computer 514, smart phone 513, a laptop computer 512, and desktop computer 511 (‘client devices’) through network(s) 510.

As discussed above, modern communication technologies enable processes to utilize a wide range of computing device and application. This means, a BIH system may use one or more devices (e.g. a regular phone, a smart phone, a computer, a smart automobile console, etc.) to facilitate communications. Depending on the capabilities of each device and applications available on each device, additional services may be enabled.

Client devices 511-514 are used to facilitate communications through a variety of modes between processes running in the communication system. A BR may be directed from a BIH controller to a BIH consumer through the communication system to induce a desired state in a product process. Information associated with processes, BIH system, and other data, may be stored in one or more data stores (e.g. data store 517), which may be managed by any one of the servers 518 or by database server 516.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a communication system where BR(s) may be directed from BIH controller(s) to BIH consumer(s) to invoke product state(s). Furthermore, the networked environments discussed in FIG. 5 are for illustration purposes only. Embodiments are not limited to the example applications, modules, or processes.

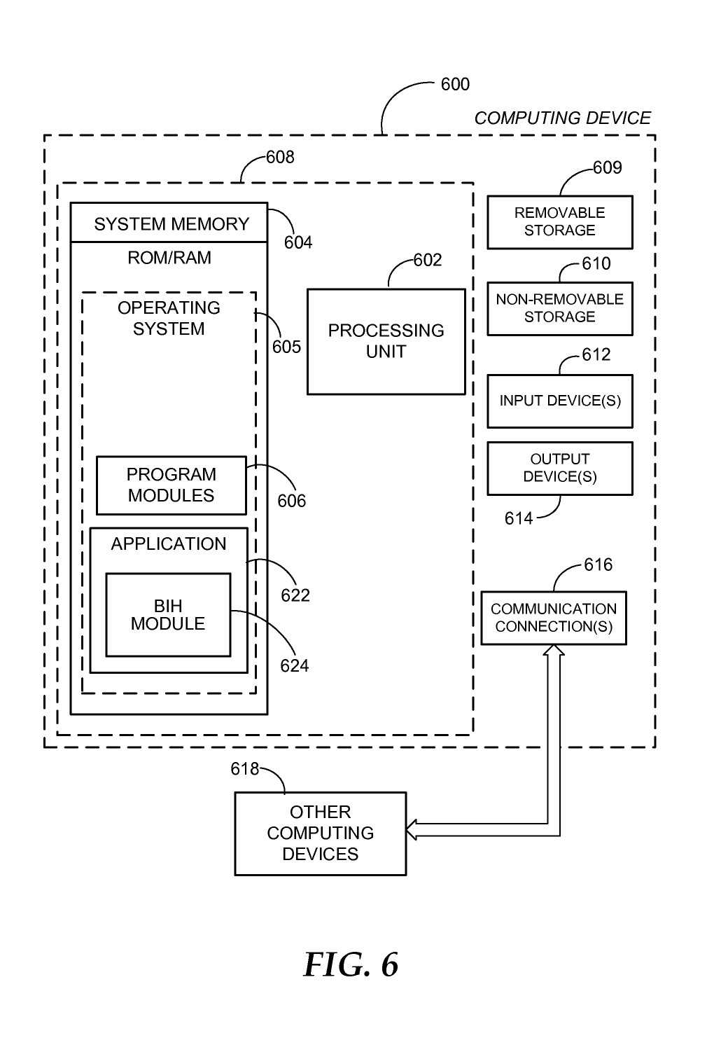

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a client device and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® operating systems from MICROSOFT CORPORATION of Redmond, Wash. The system memory 604 may also include one or more software applications such as program modules 606, application 622, and BIH module 624.

Application 622 may be any application whose processes can be influenced through behavior requests sent by a BIH controller at a test control center. BIH module 624 may enable client applications such as application 622 to use BRs to induce desired state in a product process. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, test executable processes, and the like. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

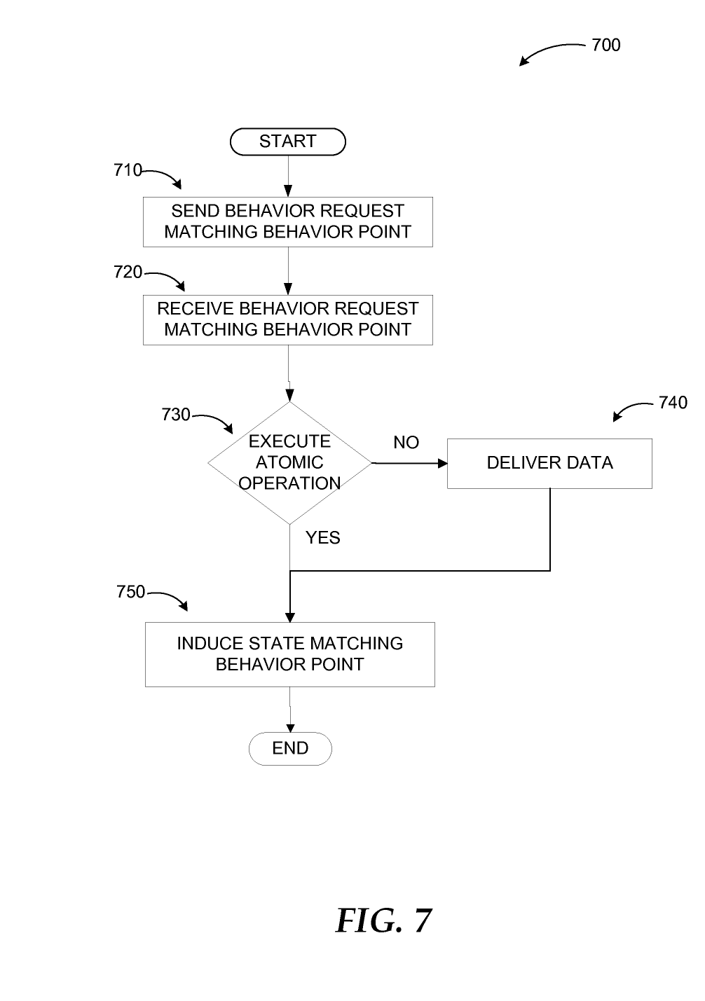

FIG. 7 illustrates a logic flow diagram for process 700 of providing a BR to induce a state in a product process. Process 700 may be implemented as part of a diagnostics system employing BIH to induce product state(s).

Process 700 begins with operation 710, where a BIH controller sends a BR matching a BP in a product process to a BIH consumer to induce a state in the product process. At operation 720, BIH consumer receives the BR matching the BP in the product process. At decision node 730, a determination is made whether the BIH consumer executes an atomic operation to alter the state of a thread in the product process or not. The atomic operation may be sleep, synchronize, throw, CPU consumption, memory consumption, lock operations, or other comparable operations. If no atomic operation is executed, the BIH controller may deliver data to BR in the product process for induction of a state at operation 740. If atomic operation is executed at operation 750, the state in product process is induced by BIH consumer by enacting on the BP per BR instructions.

The operations included in process 700 are for illustration purposes. Runtime behavior alteration using behavior injection harness may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for facilitating state induction in a diagnostics system, comprising:
sending a behavior request matching a behavior point in at least one product process from a Behavior Injection Harness (BIH) controller to a BIH consumer associated with the at least one product process; and
upon receipt of the behavior request enabling the BIH consumer to perform an atomic operation such that a state on the at least one product process matching the behavior point is induced.

2. The method of claim 1, further comprising:
upon receipt of the behavior request enabling the BIH consumer to deliver data to the at least one product process such that the state on the at least one product process matching the behavior point is induced.

3. The method of claim 1, wherein the atomic operation enables alteration of a state of a product process thread.

4. The method of claim 3, wherein the atomic operation includes one from a set of: a sleep operation, a synchronize operation, a throw operation, a CPU consumption operation, a memory consumption operation, and at least one lock operation.

5. The method of claim 1, wherein a plurality of BIH consumers are loaded by a single of product process.

6. The method of claim 1, wherein a plurality of BIH consumers are loaded by a plurality of product processes.

7. The method of claim 1, wherein the BIH consumer is a COM object.

8. The method of claim 1, wherein the behavior request comprises at least one from a set of: a behavior point ID, a BIH consumer ID, a BIH consumer context, data to be passed to the at least one product process, and a number of times the behavior point is expected to be reached before performing the behavior request.

9. The method of claim 1, wherein a shared memory is employed to facilitate communication between the BIH controller and the BIH consumer.

10. The method of claim 1, wherein the BIH consumer is enabled to induce the state on the at least one product process at a plurality of behavior points.

11. A diagnostics system to induce a desired state in a product process, the system comprising:
a server configured to:
load a test executable and initialize a BIH controller associated with the test executable defining one of data to be delivered and atomic functions to be executed at predefined behavior point in a BIH enabled product process;
send a behavior request matching at least one behavior point to the BIH enabled product process from the BIH controller;
a client device configured to:
receive the behavior request matching the at least one behavior point at a BIH consumer;
if an atomic function is defined in the behavior request, execute the atomic operation on the specified at least one behavior point of the product process by the BIH consumer; and
if data is delivered from the BIH controller, provide the delivered data to the specified at least one behavior point of the product process.

12. The system of claim 11, wherein the server is further configured to create through the BIH controller a shared memory file to communicate with the BIH consumer of the client device.

13. The system of claim 11, wherein the server is further configured to induce a desired state on the product process matching the at least one behavior point through the BIH consumer.

14. The system of claim 11, wherein a complexity of the delivered data by the behavior request depends on an implementation of the product process.

15. The system of claim 11, wherein the behavior request sent by BIH controller is executed by a plurality of BIH consumers loaded on a plurality of BIH enabled product processes.

16. The system of claim 11, wherein the test executable includes one of an automation software and a diagnostic console.

17. A computer-readable storage medium with instructions stored thereon for altering runtime behavior of a software application, the instructions comprising:
loading a test executable and initializing a BIH controller associated with the test executable defining one of data to be delivered and atomic functions to be executed at predefined behavior point in a BIH enabled product process;
sending a behavior request matching at least one behavior point to a BIH consumer at the BIH enabled product process from the BIH controller employing a shared memory between the BIH controller and the BIH consumer;
upon receiving the behavior request matching the at least one behavior point at a BIH consumer, enabling the BIH consumer to perform one of:
executing an atomic operation on the specified at least one behavior point of the product process by the BIH consumer if the atomic function is defined by the test executable; and
providing the delivered data to the specified at least one behavior point of the product process if data is delivered from the BIH controller; and
inducing a desired state on the BIH enabled product process through the BIH consumer.

18. The computer-readable storage medium of claim 17, wherein the behavior request includes at least one from a set of: a behavior point ID, a BIH consumer ID, a BIH consumer context, data to be passed to the at least one product process, a number of times the behavior point is expected to be reached before performing the behavior request, and a data type.

19. The computer-readable storage medium of claim 17, wherein the instructions further comprise:
submitting a validation test case to the BIH consumer for verifying a state of the BIH enabled product process; and
receiving a validation response from the BIH consumer.

20. The computer-readable storage medium of claim 17, wherein the instructions further comprise:
sending a plurality of behavior requests to compose a behavior request scenario for reproduction of a particular product process behavior.
